(19) United States
(12) Patent Application Publication
(10) Pub. No.: US 2019/0155929 A1
(43) Pub. Date: May 23, 2019

(54) SYSTEMS AND METHODS FOR AUTOMATED QUERY EXPANSION

(71) Applicant: Facebook, Inc., Menlo Park, CA (US)

(72) Inventors: Komal Kapoor, Bellevue, WA (US); Bradley Ray Green, Snohomish, WA (US); Yunzhi Ye, Seattle, WA (US); Yixin Li, Kirkland, WA (US)

(21) Appl. No.: 15/817,123

(22) Filed: Nov. 17, 2017

(51) Int. Cl. G06F 17/30

(52) U.S. Cl. CPC G06F 17/30395; G06F 17/30864

(57) ABSTRACT

Systems, methods, and non-transitory computer-readable media can receive a user query comprising one or more search terms. One or more synonyms are identified for the user query based on a dynamic thesaurus generated using automated synonym extraction. An expanded query is generated based on the user query and the one or more synonyms. One or more search results are identified based on the expanded query.

### FIELD OF THE INVENTION

The present technology relates to the field of electronic queries. More particularly, the present technology relates to systems and methods for automated query expansion.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

A social networking system can include pages that are associated with entities. The pages can be dedicated locations on the social networking system to reflect the presence of the entities on the social networking system. The users and entities associated with such pages can be provided with the opportunity to interact with other users on the social networking system. Users can also be provided with the ability to enter queries (e.g., text queries) to search for pages on the social networking system.

### SUMMARY

Various embodiments of the present disclosure can include systems, methods, and non-transitory computer readable media configured to receive a user query comprising one or more search terms. One or more synonyms are identified for the user query based on a dynamic thesaurus generated using automated synonym extraction. An expanded query is generated based on the user query and the one or more synonyms. One or more search results are identified based on the expanded query.

In an embodiment, the dynamic thesaurus comprises one or more synonyms automatically extracted based on a plurality of page clusters on a social networking system, each page cluster of the plurality of page clusters comprising one or more pages.

In an embodiment, each page cluster of the plurality of page clusters is associated with a particular entity, and each page in a page cluster is selected for inclusion in the page cluster based on an association with the particular entity.

In an embodiment, the dynamic thesaurus comprises one or more synonyms automatically extracted based on cross-linking of publications.

In an embodiment, the dynamic thesaurus comprises one or more synonyms automatically extracted based on query reformulation data.

In an embodiment, the dynamic thesaurus comprises one or more synonyms automatically extracted based on reformulation likelihood scores calculated using the query reformulation data, each reformulation likelihood score is associated with a pair of queries, and each reformulation likelihood score is indicative of a likelihood that a first query of the pair of queries will be reformulated to a second query of the pair of queries.

In an embodiment, the expanded query comprises a plurality of sub-queries.

In an embodiment, the identifying one or more search results based on the expanded query comprises retrieving result candidates for each sub-query of the plurality of sub-queries.

In an embodiment, the user query is segmented into a plurality of query segments, and the identifying one or more synonyms for the user query comprises identifying one or more synonyms for the plurality of query segments.

In an embodiment, the dynamic thesaurus comprises a first set of synonyms automatically extracted based on a plurality of page clusters on a social networking system, each page cluster of the plurality of page clusters comprising one or more pages; a second set of synonyms automatically extracted based on cross-linking of publications; and a third set of synonyms automatically extracted based on query reformulation data.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an expanded query module, according to an embodiment of the present disclosure.

FIG. 2 illustrates an example synonym extraction module, according to various embodiments of the present disclosure.

FIG. 3 illustrates an example query execution module, according to various embodiments of the present disclosure.

FIG. 4 illustrates an example functional block diagram associated with automated query expansion, according to various embodiments of the present disclosure.

FIG. 5 illustrates an example method associated with automated query expansion, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Automated Query Expansion

People use computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

The social networking system may provide pages for various entities. For example, pages may be associated with companies, businesses, brands, products, artists, public figures, entertainment, individuals, and other types of entities. The pages can be dedicated locations on the social networking system to reflect the presence of the entities on the social networking system. A page can publish content that is deemed relevant to its associated entity to promote engagement with the page. Pages on the social networking system may provide users of the social networking system with an opportunity to discover and interact with the various entities associated with the pages.

Under conventional approaches, users may be provided with the ability to enter queries (e.g., textual queries) to search for pages on the social networking system. For example, a user can be provided with a search box within which the user can enter one or more search terms. A set of search results comprising one or more pages can be provided to the user based on the one or more search terms. However, it may be the case that a single entity can be referred to by different names. For example, the publication The New York Times may be referred to as NY Times, or NYT. When a user enters a query, the user may expect results corresponding to all different forms of an entity name, rather than results that correspond only to the literal terms entered. For example, if a user enters a query for “NYT,” the user may expect to see search results that include a page for “The New York Times.” However, under conventional approaches, a search for the entered search term “NYT” may not result in the page for “The New York Times” being identified as a search result due to differences in the entered query and the page name. As such, users may grow frustrated with search results that are perceived as incomplete. Furthermore, use of a fixed thesaurus to address such limitations is generally ineffective due to low coverage and inability to adapt to changes in language or popular culture. Conventional approaches may not be effective in addressing these and other problems arising in computer technology.

An improved approach rooted in computer technology overcomes the foregoing and other disadvantages associated with conventional approaches specifically arising in the realm of computer technology. In general, a user query can be expanded using one or more automatically extracted synonyms. Search results can be identified based on the expanded query. A dynamic thesaurus may be automatically generated and maintained using various synonym extraction techniques. Different synonym extraction techniques may, for example, leverage different sources to identify synonyms. For example, the dynamic thesaurus can include synonyms identified based on clustering of pages on a social networking system. A page in a page cluster can be identified as a synonym of another page in the page cluster (e.g., the title of one page may be identified as a synonym of the title of another page). In another example, the dynamic thesaurus can include synonyms identified based on cross-linking of articles or publications. For example, if a first publication associated with a first set of terms links to another publication associated with a second set of terms, the first and second sets of terms can be considered synonymous to one another. In yet another example, the dynamic thesaurus can include synonyms identified based on user query reformulations. For example, if users search for a first query comprising first search terms, and the first query often results in a second query comprising second search terms, the first and second search terms may be determined to be synonymous with one another. When a query is received from a user, one or more synonyms can be identified for the query based on the dynamic thesaurus. An expanded query can be generated based on the query and any identified synonyms. Search results can be determined based on the expanded query, and the search results can be presented to a user.

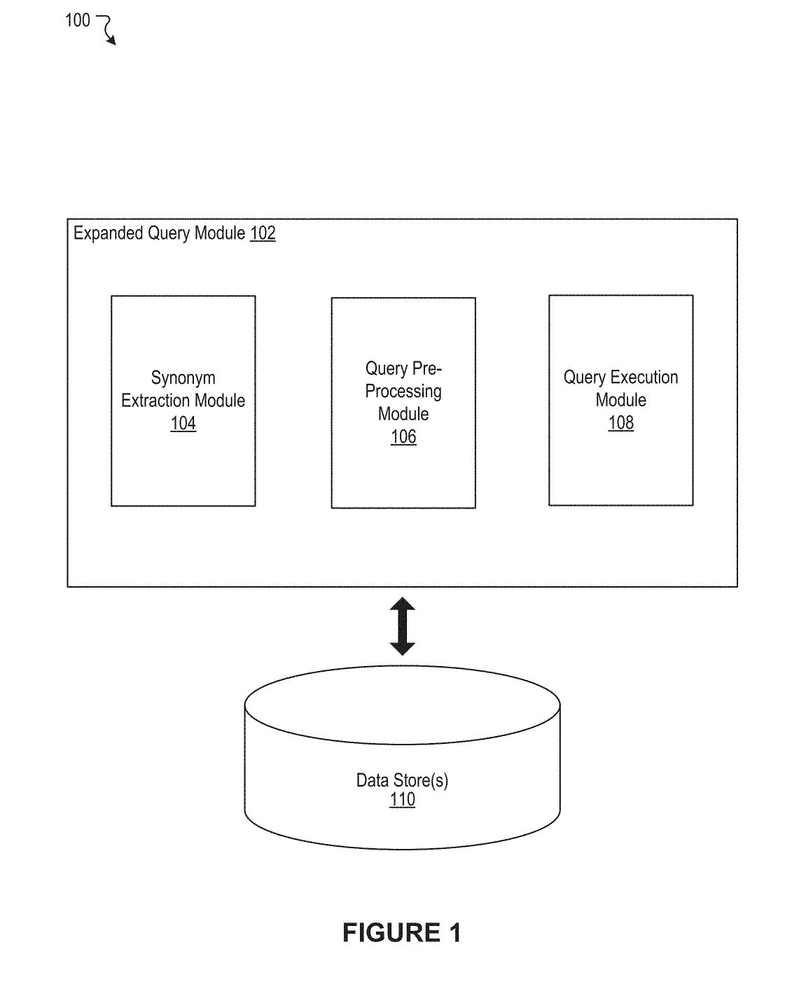

FIG. 1 illustrates an example system 100 including an example expanded query module 102, according to an embodiment of the present disclosure. The expanded query module 102 can be configured to automatically generate and/or maintain a dynamic thesaurus utilizing various synonym extraction techniques. Different synonym extraction techniques may, for example, leverage different sources to identify synonyms. For example, the expanded query module 102 can be configured to identify synonyms based on clustering of pages on a social networking system. Pages on a social networking system may be clustered together into page clusters. For example, each page cluster may be associated with a particular entity, such that pages that relate to the particular entity can be grouped together into a page cluster. For example, a first page cluster may be associated with the entity The New York Times. The first page cluster may include a page titled “The New York Times,” a page titled “NYT,” and a page titled “NY Times.” Synonymous terms may be identified based on the names and/or titles of pages in a page cluster. For example, in the example of the first page cluster associated with The New York Times, the expanded query module 102 can be configured to identify the term “The New York Times” as a synonym of the terms “NYT” and “NY Times” based on titles of pages in the first page cluster.

In another example, the expanded query module 102 can be configured to identify synonyms based on cross-linking of articles or publications. If a first publication is associated with a first set of terms, and the first publication links to another publication that is associated with a second set of terms, the first and second sets of terms can be identified as synonyms of one another. For example, an article about “Santa Claus” may link to a second article about “Kris Kringle,” and a third article about “Saint Nicholas.” Based on the cross-linking of these articles, the expanded query module 102 can determine that the terms “Santa Claus,” “Kris Kringle,” and “Saint Nicholas,” are synonyms, and update the dynamic thesaurus accordingly.

In yet another example, the expanded query module 102 can be configured to identify synonyms based on user query reformulations. Users may enter a first query comprising a first set of search terms, and receive a first set of results based on the first query. However, if the users are dissatisfied with the results of the first query, they may enter a second query in an attempt to identify an improved set of search results. If a large number or ratio of users search for a first set of search terms, and then search for a second set of search terms, it may be likely that the second set of search terms is related to the first set of search terms. For example, if users often search for “cars” and then follow that search with a search for “automobiles,” it is likely that the terms “cars” and “automobiles” are related to one another. The expanded query module 102 can be configured to automatically determine synonyms based on query reformulation data, and to update the dynamic thesaurus accordingly.

When a user enters a query, the expanded query module 102 can be configured to identify one or more synonyms based on the query and the dynamic thesaurus. The expanded query module 102 can generate an expanded query which comprises the query and any identified synonyms. The expanded query module 102 can identify search results based on the expanded query, and present the search results to a user. The search results provided to the user will typically be more robust due to the inclusion of one or more synonyms in the expanded query.

As shown in the example of FIG. 1, the expanded query module 102 can include an synonym extraction module 104, a query pre-processing module 106, and a query execution module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the expanded query module 102 can be implemented in any suitable combinations.

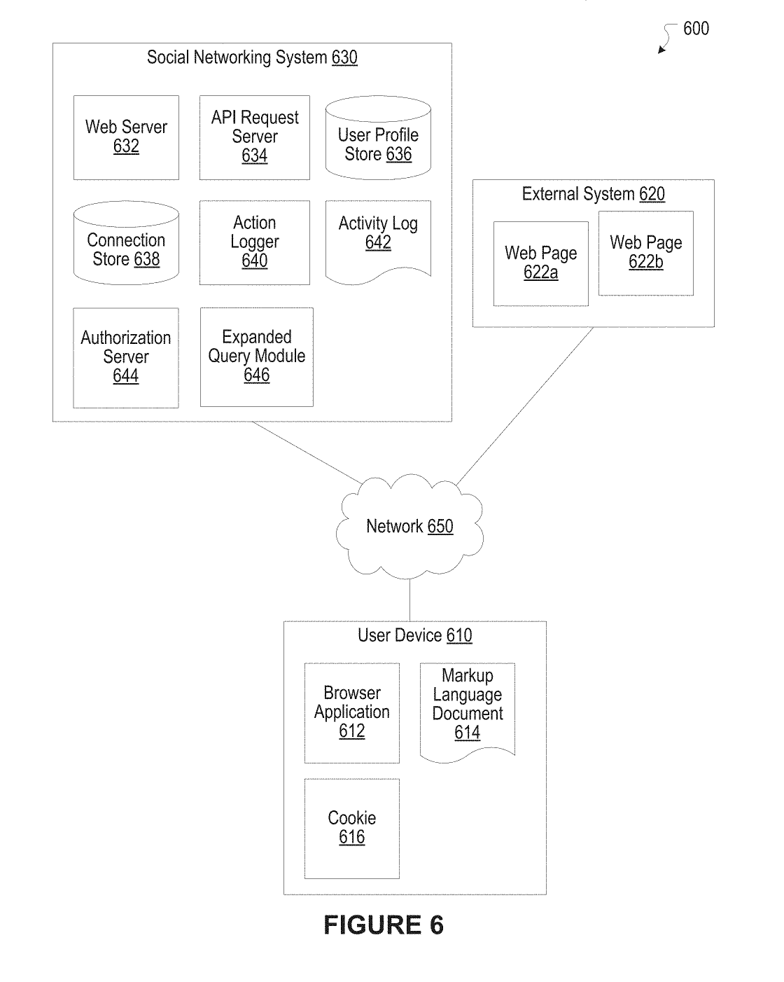

In some embodiments, the expanded query module 102 can be implemented, in part or in whole, as software, hardware, or any combination thereof. In general, a module, as discussed herein, can be associated with software, hardware, or any combination thereof. In some implementations, one or more functions, tasks, and/or operations of modules can be carried out or performed by software routines, software processes, hardware, and/or any combination thereof. In some cases, the expanded query module 102 can be implemented, in part or in whole, as software running on one or more computing devices or systems, such as on a user or client computing device. For example, the expanded query module 102, or at least a portion thereof, can be implemented as or within an application (e.g., app), a program, or an applet, etc., running on a user computing device or a client computing system, such as the user device 610 of FIG. 6. In another example, the expanded query module 102, or at least a portion thereof, can be implemented using one or more computing devices or systems that include one or more servers, such as network servers or cloud servers. In some instances, the expanded query module 102 can, in part or in whole, be implemented within or configured to operate in conjunction with a social networking system (or service), such as the social networking system 630 of FIG. 6. It should be understood that there can be many variations or other possibilities.

The expanded query module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 630 of FIG. 6). The information associated with the social networking system can include data about users, user identifiers, social connections, social engagements, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the expanded query module 102. For example, the data store 110 can store page clustering models, page clustering information, cross-linking information, a dynamic thesaurus defining synonymous relationships between terms, query reformulation data, page information, and the like. It is contemplated that there can be many variations or other possibilities.

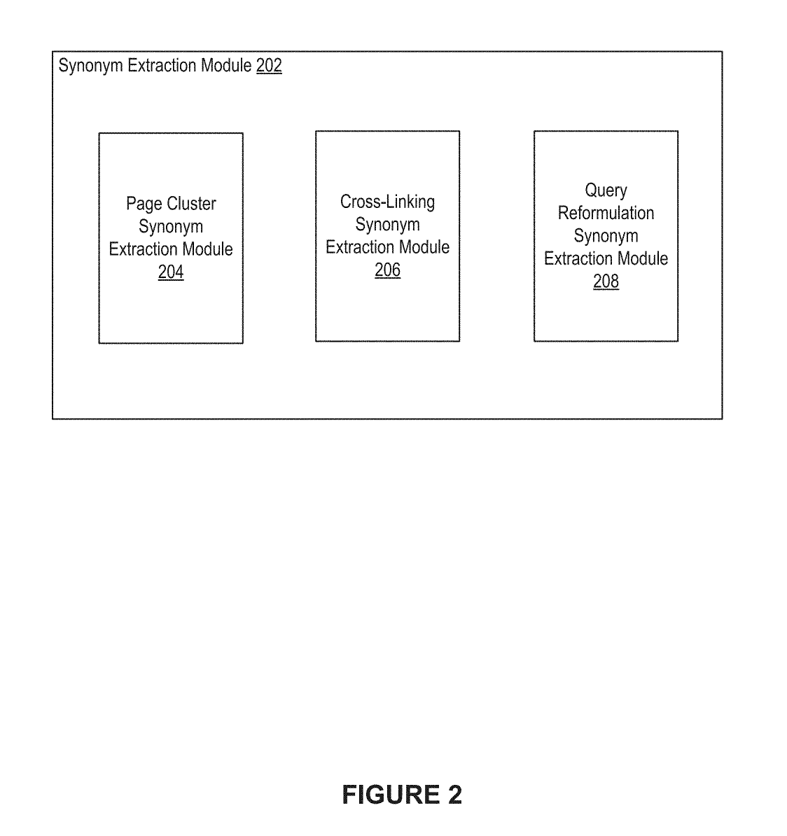

The synonym extraction module 104 can be configured to automatically generate and maintain a dynamic thesaurus. In some embodiments, the synonym extraction module 104 can be configured to automatically generate and maintain a dynamic thesaurus using unsupervised synonym extraction. The dynamic thesaurus can comprise a plurality of terms and specify synonyms for the plurality of terms. The dynamic thesaurus can be automatically generated using source data, and automatically updated based on changes to the source data. The synonym extraction module 104 can be configured to perform automatic, unsupervised extraction of synonyms utilizing various synonym extraction techniques. Different synonym extraction techniques may, for example, leverage different sources to identify synonyms. For example, the synonym extraction module 104 can be configured to identify synonyms based on clustering of pages on a social networking system. In another example, the synonym extraction module 104 can be configured to identify synonyms based on cross-linking of articles or publications. In yet another example, the synonym extraction module 104 can be configured to identify synonyms based on query reformulation data. The dynamic thesaurus can periodically or continuously be updated based on changes to source data, e.g., changes to page clusters, changes to cross-linking of articles of publications, and/or changes in query reformulation data. The synonym extraction module 104 is described in greater detail herein with reference to FIG. 2.

The query pre-processing module 106 can be configured to perform pre-processing of a user query. The user query may be, for example, a query entered by a user in order to search for pages on a social networking system. A user query can include one or more search terms. Pre-processing of a user query can include, for example, removing stop words from the one or more search terms. Stop words can include words that are common in language and are generally not useful for performing a search, such as “a” or “the.” In another example, pre-processing can include stemming, in which search terms are replaced with an associated stem word. For example, the terms “fishing”, “fished”, and “fisher” may be replaced with the stem word “fish.” In yet another example, pre-processing can include query normalization.

In various embodiments, the query pre-processing module 106 can be configured to automatically segment a user query into one or more query segments. As discussed above, a query can include one or more search terms. The one or more search terms can be grouped into one or more query segments comprising subsets of the one or more search terms. For example, a query for “bluegrass songs” can be segmented into two query segments: “bluegrass” and “songs.” In another example, a query for “The New York Times” can be segmented into “New York” and “Times.” Although the query “The New York Times” could be potentially be segmented into additional query segments (e.g., “New” or “York” or “York Times”), these additional possible query segments may not be useful for finding pages related to the original query. The query pre-processing module 106 can be configured to automatically segment a query into one or more query segments, wherein each query segment represents a meaningful subquery.

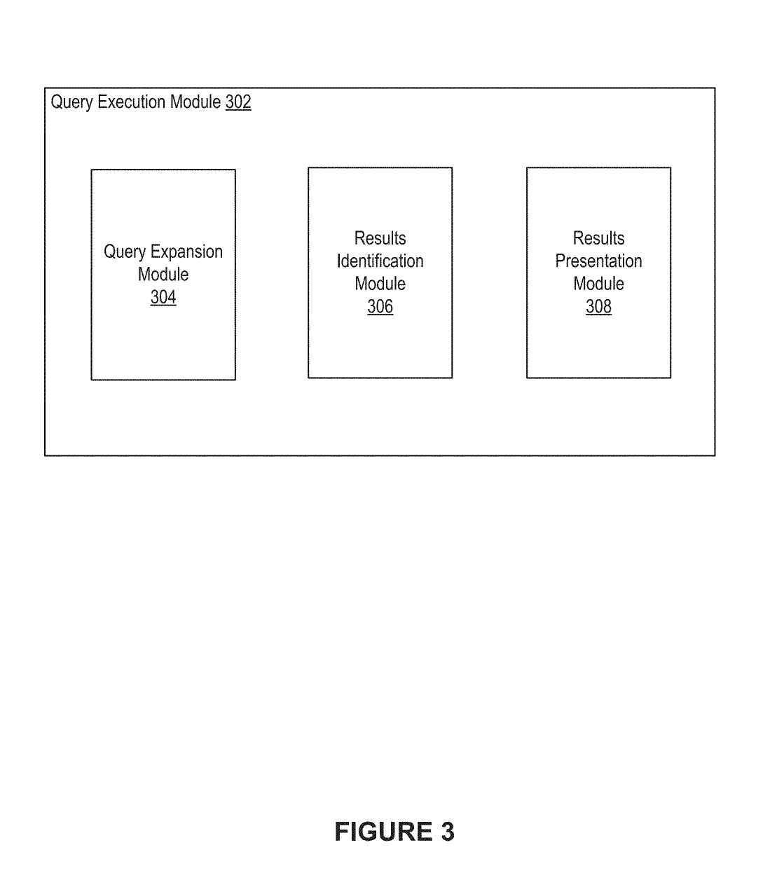

The query execution module 108 can be configured to generate an expanded query based on a query entered by a user, determine search results based on the expanded query, and present the search results to a user. In various embodiments, the query execution module 108 can receive a query and one or more query segments. The query may be a pre-processed query (e.g., a query that has been pre-processed by the query pre-processing module 106). The query execution module 108 can identify synonyms for the query and/or the one or more query segments. For example, synonyms can be identified by retrieving synonyms for the query and/or the one or more query segments from the dynamic thesaurus generated and maintained by the synonym extraction module 104. An expanded query can include both the original query and one or more variations of the query based on any identified synonyms. Search results can be obtained based on the expanded query, and the search results can be presented to a user. The query execution module 108 is described in greater detail herein with reference to FIG. 3.

FIG. 2 illustrates an example synonym extraction module 202 configured to automatically generate and maintain a dynamic thesaurus based on various source data, according to an embodiment of the present disclosure. In some embodiments, the synonym extraction module 104 of FIG. 1 can be implemented as the synonym extraction module 202. As shown in the example of FIG. 2, the synonym extraction module 202 can include a page cluster synonym extraction module 204, a cross-linking synonym extraction module 206, and a query reformulation synonym extraction module 208.

The page cluster synonym extraction module 204 can be configured to automatically extract synonyms for inclusion in a dynamic thesaurus based on clustering of pages on a social networking system. As discussed above, a page on a social networking system can be associated with a particular entity. In various embodiments, pages on the social networking system can be grouped, or clustered, into a plurality of page clusters based on association with particular entities. For example, a first set of pages on a social networking system may each be associated with the entity The New York Times. The pages in the first set of pages may have different names or titles. For example, one or more pages in the first set of pages may be named The New York Times, one or more pages in the first set of pages may be named “NY Times,” and one or more pages in the first set of pages may be named “NYT.” The first set of pages can be grouped together into a page cluster based on their association with the same entity, The New York Times. In certain embodiments, a page clustering machine learning model can be trained to automatically cluster pages on a social networking system. The page clustering machine learning model can be trained to cluster pages that are associated with the same entity. The page clustering machine learning model can be trained to determine which pages are associated with the same identity based on various factors, such as page name, a linked website associated with each page (e.g., pages that link to the same website may be associated with the same entity), co-mentions in a publication, shared followers, and the like.

The page cluster synonym extraction module 204 can identify synonymous terms based on page clusters. For example, if a first page cluster includes pages that are named (or titled) The New York Times, NY Times, and NYT, the page cluster synonym extraction module 204 can infer that the terms “The New York Times,” “NY Times,” and “NYT” are related to one another and may be treated as synonyms. The page cluster synonym extraction module 204 can update the dynamic thesaurus based on the synonyms identified from page clusters.

In certain embodiments, each page cluster can have one page identified as a best page. The best page may reflect a page determined to be the most authoritative page and/or the highest quality page in the page cluster. In certain embodiments, the best page may be selected based on various factors, such as fan count, user engagement information, and/or number of references by third party sources. In embodiments in which each page cluster has an identified best page, the best page may be identified as a synonym for each other page in the page cluster, but other pages in the page cluster may not be identified as a synonym for the best page. For example, consider an example scenario in which a page cluster includes three pages: a page titled “The New York Times”; a page titled “NY Times”; and a page titled “NYT.” The page titled “The New York Times” may be identified as the best page of the page cluster. In this example scenario, the term “The New York Times” may be identified as a synonym of the terms “NY Times” and “NYT” when the terms “NY Times” and “NYT” are included in a query, but the terms “NY Times” and “NYT” are not identified as synonyms of the term “The New York Times” when the term “The New York Times” is included in a query. Definition of synonyms in this unidirectional manner may assist in providing optimal search results, as described in greater detail herein. For example, in such implementations, when a user types in a query for “NY Times” or “NYT,” the user will be provided with the page titled “The New York Times” based on synonyms for the original query. This is a desirable result, as the page titled “The New York Times” has been identified as the best page associated with the entity The New York Times. However, when a user types in a search for “The New York Times,” the user will not be presented with the pages titled “NY Times” or “NYT” since these terms have not been identified as synonyms for “The New York Times.” This, again, is a desirable result, as these pages have been determined to be not superior (or inferior) to the page titled “The New York Times.”

The cross-linking synonym extraction module 206 can be configured to automatically extract synonyms for inclusion in a dynamic thesaurus based on cross-linking of articles and/or publications. For example, a first publication may be associated with a first set of terms, and the first publication may link to a second publication that is associated with a second set of terms. The cross-linking synonym extraction module 206 can determine that the first and second sets of terms may be synonymous to one another based on cross-linking of the first and second articles. In a more detailed example, an article about “Santa Claus” may link to a first article about “Kris Kringle” and a second article about “Saint Nicholas.” Based on the cross-linking of these articles, the cross-linking synonym extraction module 206 can determine that the terms “Santa Claus,” “Kris Kringle,” and “Saint Nicholas,” are synonyms of one another, and can update the dynamic thesaurus accordingly. In certain embodiments, the cross-linking synonym extraction module 206 can determined synonyms based on cross-linked articles on a particular online platform, such as the online encyclopedia Wikipedia.

In certain embodiments, the cross-linking synonym extraction module 206 can implement a number of mentions threshold to help ensure the quality of synonyms that are learned. For example, an article about Santa Claus may link to articles for Kris Kringle, Saint Nicholas, reindeer, and elves. However, the article about Santa Claus may mention Kris Kringle 15 times, Saint Nicholas 14 times, reindeer 4 times, and elves 3 times. A number of mentions threshold can be implemented such that only terms that are mentioned a number of times that is equal to or greater than the threshold are identified as synonyms. In an example scenario where the number of mentions threshold has a value of 10 times, Kris Kringle and Saint Nicholas would be identified as synonyms of Santa Claus based on satisfaction of the number of mentions threshold, while reindeer and elves would not. The number of mentions threshold may vary from case to case, and can be identified based on one or more machine learning processes and/or statistical studies.

The query reformulation synonym extraction module 208 can be configured to automatically extract synonyms for inclusion in a dynamic thesaurus based on query reformulation data. Query reformulation data can include historical user query information indicative of past queries users have made, and the order in which queries were made. For example, a user may enter a first query comprising a first set of search terms, and receive a first set of results based on the first query. However, if the user is dissatisfied with the results of the first query, the user may enter a second query in an attempt to identify an improved set of search results. If query reformulation data indicate that many users have transitioned from the first query to the second query, this may be indicative of a relationship between the search terms of the first query and the search terms of the second query.

The query reformulation synonym extraction module 208 can be configured to calculate, based on query reformulation data, reformulation likelihood scores and reformulation confidence scores. Each reformulation likelihood score can be associated with a pair of queries (e.g., a first query and a second query), and is indicative of a likelihood that the first query will be reformulated into the second query. For example, if a particular query Q1 occurs n times, and a reformulation from the query Q1 to another query Q2 (i.e., Q1→Q2) happens rtimes, the reformulation likelihood score for the pair (Q1, Q2) can be calculated as r/n. A reformulation confidence score can also be associated with a pair of queries, and is indicative of a reliability of the query pair's reformulation likelihood score. The reformulation confidence score can be equal to or positively correlated to n, such that the greater the value of n, the more reliable the reformulation likelihood score. In various embodiments, the query reformulation synonym extraction module 208 can identify synonyms based on a reformulation likelihood score threshold and a reformulation confidence score threshold. For example, all query pairs with a reformulation likelihood score greater than 0.5 and a confidence score greater than 1000 can be determined to be synonyms to be included in a dynamic thesaurus. In certain embodiments, the query reformulation data used to calculate the reformulation likelihood scores and the reformulation confidence scores can be constrained to a particular period of time, e.g., the last month, the last three months, the last year, etc.

FIG. 3 illustrates an example query execution module 302 configured to generate an expanded query, identify search results based on the expanded query, and present the search results to a user, according to an embodiment of the present disclosure. In some embodiments, the query execution module 108 of FIG. 1 can be implemented as the query execution module 302. As shown in the example of FIG. 3, the query execution module 302 can include a query expansion module 304, a results identification module 306, and a results presentation module 308.

The query expansion module 304 can be configured to generate an expanded query based on a query and a dynamic thesaurus. In various embodiments, the query expansion module 304 can receive a query and/or one or more query segments. The query expansion module 304 can identify synonyms for the query and/or the one or more query segments based on the dynamic thesaurus. The query expansion module 304 can generate an expanded query comprising the query and any identified synonyms. In certain embodiments, an expanded query can comprise a plurality of sub-queries. For example, consider an example scenario in which a user enters a query for “New York City Pizza.” The query may include query segments “New York City” and “Pizza.” The query expansion module 304 can identify synonyms for the query as a whole (e.g., “New York City Pizza” may be synonymous with “New York-Style Pizza”), as well as for individual query segments (e.g., “New York City” may be synonymous with “NYC” and “NY City”; and “Pizza” may be synonymous with “Pizza Pie.”) The resulting expanded query may include a plurality of sub-queries, including the original query (New York City Pizza) and various combinations of the query segments and the identified synonyms. In this example scenario, the expanded query may include the following sub-queries: New York City Pizza, New York-Style Pizza, NYC Pizza, NY City Pizza, New York City Pizza Pie, NYC Pizza Pie, NY City Pizza Pie, and the like.

The results identification module 306 can be configured to identify a set of search results based on an expanded query. As described above, in certain embodiments, an expanded query can include a plurality of sub-queries. The results identification module 306 can be configured to retrieve search results for each sub-query in an expanded query, wherein each search result is treated a potential search result for the user's query, i.e., a result candidate. For example, in the example scenario discussed above in which a user enters a query for “New York City Pizza,” the results identification module 306 can be configured to run an individual query for each sub-query in the expanded query, i.e., New York City Pizza, New York-Style Pizza, NYC Pizza, NY City Pizza, New York City Pizza Pie, NYC Pizza Pie, NY City Pizza Pie. Search results from each sub-query can be treated as a potential result for the original user query, and aggregated into a set of result candidates.

In various embodiments, the results identification module 306 can be configured to rank the set of result candidates based on ranking criteria. For example, the set of result candidates can be ranked based on how closely each result candidate matches an initial user-inputted query. In certain embodiments, result candidates can be ranked based on a synonym quality score indicative of a quality of a synonym used to obtain a particular result candidate. For example, if a user enters a query for “San Francisco,” synonyms for San Francisco may include “SF” or “San Fran.” The synonym “SF” may have a higher synonym quality score than the synonym “San Fran.” As such, result candidates obtained based on a sub-query for “SF” may be upranked compared to result candidates obtained based on a sub-query for “San Fran.” The results identification module 306 can be configured to filter the set of result candidates based on filtering criteria. For example, the ranked set of result candidates can be filtered such that the top n result candidates are selected for a final set of search results to be provided to a user.

The results presentation module 308 can be configured to present one or more search results to a user. For example, a final set of search results determined by the results identification module 306 can be presented to a user. The one or more search results can be presented in a user interface in which a user is presented with an ordered set of search results. The user can select a particular search result to access the search result. For example, if a user has entered a query for pages on a social networking system, the user can be presented with a set of search results, with each search result being associated with a page that matches the user's query. The user can select a particular search result to access the page associated with the search result.

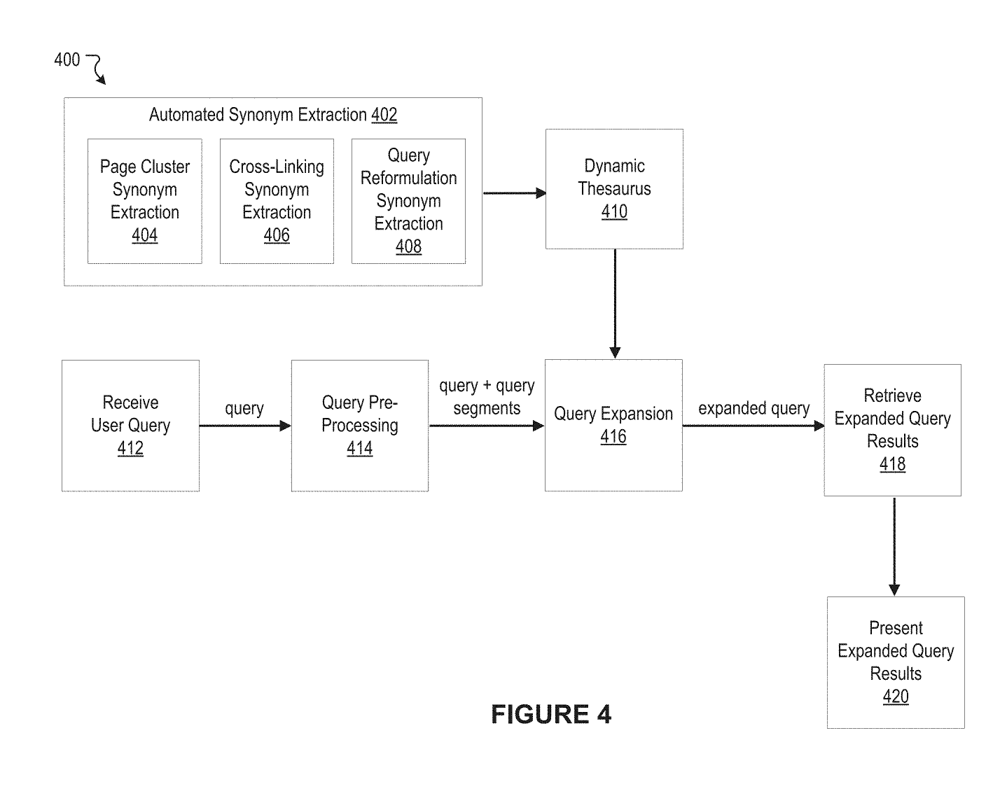

FIG. 4 illustrates an example functional block diagram 400 associated with automated query expansion, according to various embodiments of the present disclosure. At block 402, a dynamic thesaurus 410 is automatically generated based on various sets of source data and synonym extraction techniques. For example, at block 404, a first set of synonyms is automatically extracted based on page clusters on a social networking system. The first set of synonyms is included in the dynamic thesaurus 410. In another example, at block 406, a second set of synonyms is automatically extracted based on cross-linking of articles (e.g., Wikipedia articles). The second set of synonyms is included in the dynamic thesaurus 410. In yet another example, at block 408, a third set of synonyms is automatically extracted based on query reformulation data (e.g., query reformulation data maintained by a social networking system). The third set of synonyms is included in the dynamic thesaurus 410.

At block 412, a user query is received. At block 414, the user query is pre-processed, including identification of one or more query segments of the user query. At block 416, the query is expanded based on the dynamic thesaurus 410 to generate an expanded query. Expansion of the query may include identifying synonyms for the query and/or the one or more sub-queries in the dynamic thesaurus 410. The expanded query can comprise a plurality of sub-queries generated based on the query and any identified synonyms. At block 418, a set of search results can be retrieved based on the expanded query. At block 420, the set of search results can be presented to a user, for example, via a user interface.

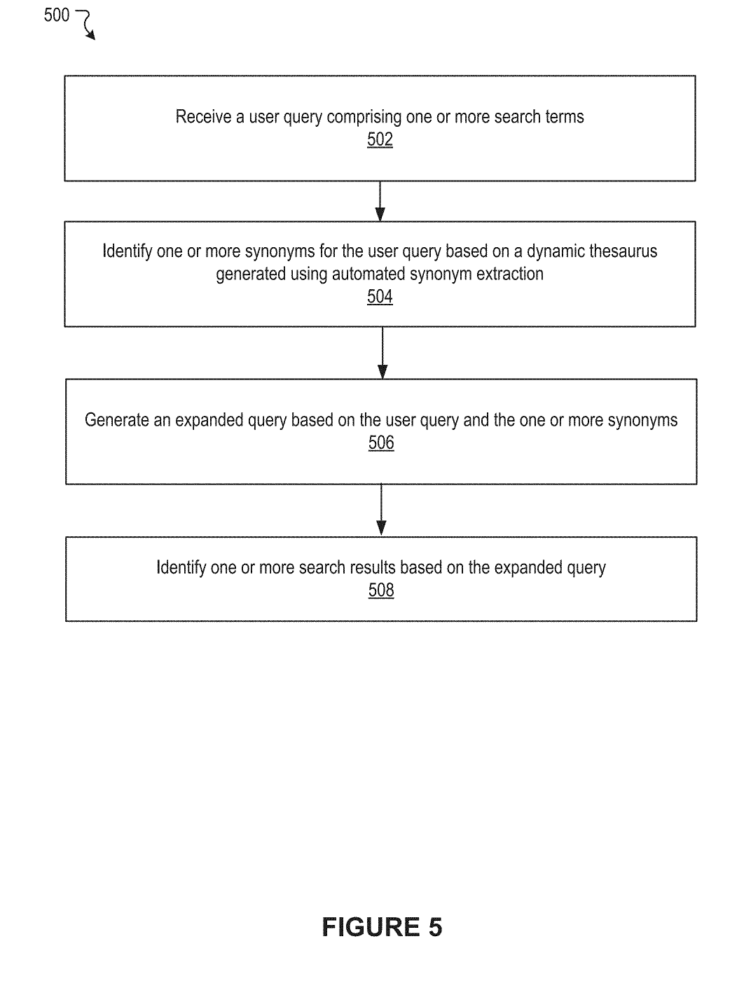

FIG. 5 illustrates an example method 500 associated with automated query expansion, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can receive a user query comprising one or more search terms. At block 504, the example method 500 can identify one or more synonyms for the user query based on a dynamic thesaurus generated using automated synonym extraction. At block 506, the example method 500 can generate an expanded query based on the user query and the one or more synonyms. At block 508, the example method 500 can identify one or more search results based on the expanded query.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing engagements between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and engagements with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and engagements.

The social networking system 630 also includes user-generated content, which enhances a user's engagements with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the engagement of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the engagements and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's engagement with an external system 620 from the web server 632. In this example, the external system 620 reports a user's engagement according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing engagements between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include an expanded query module 646. The expanded query module 646 can, for example, be implemented as the expanded query module 102, as discussed in more detail herein. As discussed previously, it should be appreciated that there can be many variations or other possibilities. For example, in some embodiments, one or more functionalities of the expanded query module 646 can be implemented in the user device 610.

### Hardware Implementation

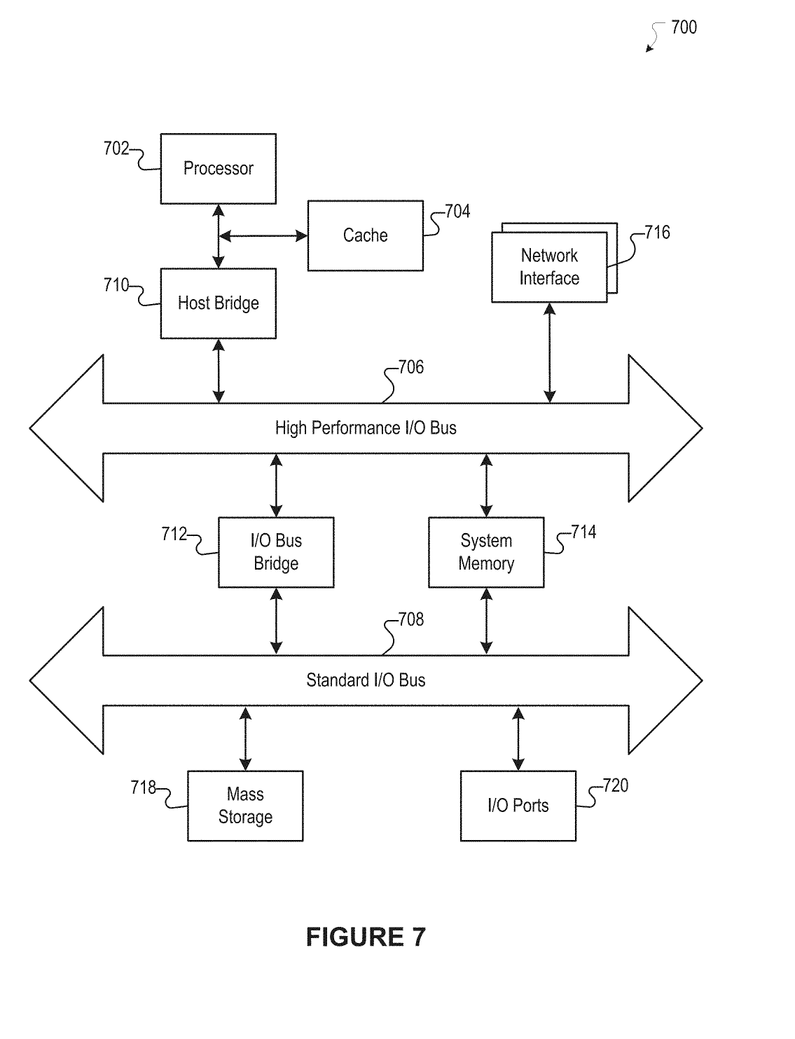

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, a user query comprising one or more search terms;
identifying, by the computing system, one or more synonyms for the user query based on a dynamic thesaurus generated using automated synonym extraction;
generating, by the computing system, an expanded query based on the user query and the one or more synonyms; and
identifying, by the computing system, one or more search results based on the expanded query.

2. The computer-implemented method of claim 1, wherein the dynamic thesaurus comprises one or more synonyms automatically extracted based on a plurality of page clusters on a social networking system, each page cluster of the plurality of page clusters comprising one or more pages.

3. The computer-implemented method of claim 2, wherein
each page cluster of the plurality of page clusters is associated with a particular entity, and
each page in a page cluster is selected for inclusion in the page cluster based on an association with the particular entity.

4. The computer-implemented method of claim 1, wherein the dynamic thesaurus comprises one or more synonyms automatically extracted based on cross-linking of publications.

5. The computer-implemented method of claim 1, wherein the dynamic thesaurus comprises one or more synonyms automatically extracted based on query reformulation data.

6. The computer-implemented method of claim 5, wherein
the dynamic thesaurus comprises one or more synonyms automatically extracted based on reformulation likelihood scores calculated using the query reformulation data,
each reformulation likelihood score is associated with a pair of queries, and
each reformulation likelihood score is indicative of a likelihood that a first query of the pair of queries will be reformulated to a second query of the pair of queries.

7. The computer-implemented method of claim 1, wherein the expanded query comprises a plurality of sub-queries.

8. The computer-implemented method of claim 7, wherein the identifying one or more search results based on the expanded query comprises retrieving result candidates for each sub-query of the plurality of sub-queries.

9. The computer-implemented method of claim 1, further comprising segmenting the user query into a plurality of query segments, wherein
the identifying one or more synonyms for the user query comprises identifying one or more synonyms for the plurality of query segments.

10. The computer-implemented method of claim 1, wherein the dynamic thesaurus comprises:
a first set of synonyms automatically extracted based on a plurality of page clusters on a social networking system, each page cluster of the plurality of page clusters comprising one or more pages;
a second set of synonyms automatically extracted based on cross-linking of publications; and
a third set of synonyms automatically extracted based on query reformulation data.

11. A system comprising:
at least one processor; and
a memory storing instructions that, when executed by the at least one processor, cause the system to perform a method comprising:
receiving a user query comprising one or more search terms;
identifying one or more synonyms for the user query based on a dynamic thesaurus generated using automated synonym extraction;
generating an expanded query based on the user query and the one or more synonyms; and
identifying one or more search results based on the expanded query.

12. The system of claim 11, wherein the dynamic thesaurus comprises one or more synonyms automatically extracted based on a plurality of page clusters on a social networking system, each page cluster of the plurality of page clusters comprising one or more pages.

13. The system of claim 12, wherein
each page cluster of the plurality of page clusters is associated with a particular entity, and
each page in a page cluster is selected for inclusion in the page cluster based on an association with the particular entity.

14. The system of claim 11, wherein the dynamic thesaurus comprises one or more synonyms automatically extracted based on cross-linking of publications.

15. The system of claim 11, wherein the dynamic thesaurus comprises one or more synonyms automatically extracted based on query reformulation data.

16. A non-transitory computer-readable storage medium including instructions that, when executed by at least one processor of a computing system, cause the computing system to perform a method comprising:
receiving a user query comprising one or more search terms;
identifying one or more synonyms for the user query based on a dynamic thesaurus generated using automated synonym extraction;
generating an expanded query based on the user query and the one or more synonyms; and
identifying one or more search results based on the expanded query.

17. The non-transitory computer-readable storage medium of claim 16, wherein the dynamic thesaurus comprises one or more synonyms automatically extracted based on a plurality of page clusters on a social networking system, each page cluster of the plurality of page clusters comprising one or more pages.

18. The non-transitory computer-readable storage medium of claim 17, wherein
each page cluster of the plurality of page clusters is associated with a particular entity, and
each page in a page cluster is selected for inclusion in the page cluster based on an association with the particular entity.

19. The non-transitory computer-readable storage medium of claim 16, wherein the dynamic thesaurus comprises one or more synonyms automatically extracted based on cross-linking of publications.

20. The non-transitory computer-readable storage medium of claim 16, wherein the dynamic thesaurus comprises one or more synonyms automatically extracted based on query reformulation data.
